(19) United States
(12) Patent Application Publication
(10) Pub. No.: US 2008/0140625 A1
(43) Pub. Date: Jun. 12, 2008

(54) SYSTEM AND METHOD FOR PROVIDING GEOSPATIAL INFORMATION PROCESSING SERVICES USING WEB SERVICE TECHNOLOGIES

(75) Inventors: Yoon-Seop CHANG, Daejeon (KR); Sung Woong SHIN, Daejeon (KR); Kyung Ok KIM, Daejeon (KR)

Correspondence Address: RABIN & Berdo, PC, 1101 14TH STREET, NW, SUITE 500, WASHINGTON, DC, 20005, US

(73) Assignee: Electronics and Telecommunications Research Institute, Daejeon (KR)

(21) Appl. No.: 11/780,328

(22) Filed: Jul. 19, 2007

(30) Foreign Application Priority Data
Dec. 8, 2006 (KR) 10-2006-0124290
Jun. 29, 2007 (KR) 10-2007-0065267

(51) Int. Cl. G06F 17/30

(52) U.S. Cl. 707/3; 707/E17.108

(57) ABSTRACT

A system for providing geospatial information processing services using web service technologies via a network includes: one or more geospatial information databases storing therein geospatial information; a geospatial information processing service provider including one or more geospatial information processing servers having a plurality of geospatial information processing web service components for performing geospatial information processing unit functions; and a user terminal including a client software for accessing the geospatial information processing servers via the network to select one or more of the geospatial information processing web service components and transmit a user request. The geospatial information processing servers accesses the geospatial information databases via the network to transmit a query based on the user request and transmits to the user terminal a geospatial information processing service result based on a query result received from the geospatial information databases, by using the selected geospatial information processing web service components.

### FIELD OF THE INVENTION

The present invention relates to a system and a method for providing geospatial information processing services; and, more particularly, to a system and a method for providing geospatial information processing services using web service technologies.

### BACKGROUND OF THE INVENTION

A term of geospatial information processing refers to a series of processes that collect, process, treat and supply geographical or geospatial information, and can be generally classified into two categories: remote sensing and GIS (Geographical Information System). The remote sensing technology is for acquiring useful geospatial information on the surface of the earth and the landform by processing data collected from sensors mounted on satellites, aircrafts or the like. Further, the GIS is a decision support system for the geospatial location by processing and analyzing the geospatial information such as satellite or aerial images, topographic data, digital maps, land cover classification or the like. The geospatial information processing system could be a hardware and/or software system for providing a variety of geospatial information obtained from the remote sensing or the GIS and analysis results based on the geospatial information in response to the user request.

With the advancement of electrical engineering and information technology, the geospatial information processing system has been greatly developed as well. Further, a geospatial information processing technology has been significantly developed by the development of its constituent technologies such as a digital communications technology, a semiconductor manufacturing technology, a GPS (Global Positioning System) technology, a database technology and the like.

However, regardless of such developments in the geospatial information processing technology, the use of the geospatial information processing service and user understanding on how to use this service still do not meet the expected level.

One of the reasons for the lack of use and understanding is that the conventional geospatial information processing service is mostly provided in the form of a software package. A service provider is a software seller who develops and sells a geospatial information processing software in the form of a software package, and the user purchases and uses the software package.

As described above, the geospatial information processing service provides various kinds of geospatial information and a variety of analysis tools (functions) to analyze the geospatial information. Since the geospatial information processing service provides a wide range of the geospatial information, the software package usually includes all of these various functions. Further, even though the software package supports a restricted range of the functions, it still includes numerous functions which are not necessary for a specific user. Therefore, most users purchase geospatial information processing software packages containing various unnecessary functions, and pay extra money to maintain and manage the overly-featured geospatial information processing software.

Furthermore, since the conventional geospatial information processing software is individually repaired and upgraded by users who purchased the package, the repair and upgrade processes are not only complicated, but also very costly.

### SUMMARY OF THE INVENTION

It is, therefore, an object of the present invention to provide a system and a method for providing more affordable geospatial information processing services capable of reducing maintenance cost of a geospatial information processing software by componentizing various geospatial information processing functions into web service components and allowing users to select and use components related to the intended service.

It is another object of the present invention to provide a system and a method for providing geospatial information processing services capable of simplifying service maintenance processes and minimizing the time and cost for the maintenance by performing the repair and upgrade of a geospatial information processing service provided to the users through the repair and upgrade of web service components.

In accordance with a first of the present invention, there is provided a system for providing geospatial information processing services using web service technologies via a network, the system including:

one or more geospatial information databases storing therein geospatial information;

a geospatial information processing service provider including one or more geospatial information processing servers having a plurality of geospatial information processing web service components for performing geospatial information processing unit functions; and

a user terminal including a client software for accessing the geospatial information processing servers via the network to select one or more of the geospatial information processing web service components and transmit a user request for a geospatial information processing service executed by the selected geospatial information processing web service components,

wherein the geospatial information processing servers accesses the geospatial information databases via the network to transmit a query based on the user request and receive a query result and transmits to the user terminal a geospatial information processing service result based on the query result received from the geospatial information databases, by using the selected geospatial information processing web service components.

It is preferable that the system for providing geospatial information processing services further includes:

a service registry registered therein service information on the geospatial information processing web service components; and

a relay server for receiving the service information on the geospatial information processing web service components from the geospatial information processing servers to register the service information in the service registry and for searching for the service information in the service registry to provide the user with the searched service information.

In accordance with a second aspect of the present invention, there is provided a method for providing geospatial information processing services using geospatial information stored in one or more geospatial information databases and a plurality of geospatial information processing web service components for performing geospatial information processing unit functions, the method including:

receiving from a user a user request for a geospatial information processing service executed by one or more of the geospatial information processing web service components;

transmitting to the geospatial information databases a query based on the user request and receiving a query result from the geospatial information databases;

performing the requested geospatial information processing service by using the geospatial information processing web service components based on the query result; and

transmitting to the user a geospatial information processing service result.

In accordance with the system and the method for providing geospatial information processing services of the present invention, the repair and upgrade of the software by the service providers as well as the use of the geospatial information processing services provided by a plurality of service providers can be systemically and conveniently performed.

Further, purchase price and maintenance cost of the software can be reduced from user's point of view by componentizing various geospatial information processing service functions into web service components.

Furthermore, by additionally installing the relay server for registering service information on the geospatial information processing web service components provided by the plurality of service providers in a service registry and managing the service registry, the users can easily search for a service they want and the service provider can bill the users efficiently.

### BRIEF DESCRIPTION OF THE DRAWINGS

The above and other objects and features of the present invention will become apparent from the following description of embodiments given in conjunction with the accompanying drawings, in which:

FIG. 1 shows components in a system for providing geospatial information processing services in accordance with an embodiment of the present invention;

FIG. 2 describes data flow between components in a system for providing geospatial information processing services including a relay server in accordance with another embodiment of the present invention; and

FIG. 3 illustrates a flow chart of a method for providing geospatial information processing services in accordance with the present invention.

### DETAILED DESCRIPTION OF THE EMBODIMENTS

Hereinafter, embodiments of a system and a method for providing geospatial information processing services of the present invention will be described in detail with reference to the accompanying drawings so that they can be readily implemented by those skilled in the art.

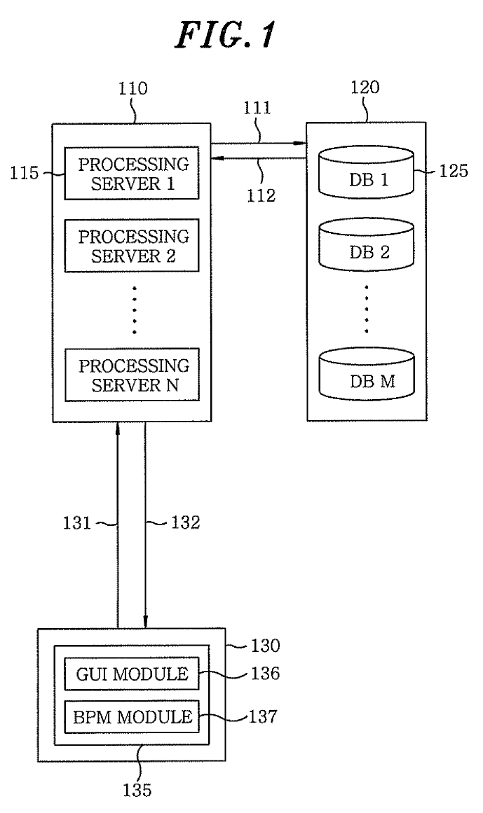

FIG. 1 describes components in a system, which are for providing geospatial information processing services in accordance with an embodiment of the present invention.

A service provider 110 includes one or more geospatial information processing servers 115, and various geospatial information processing unit functions of the geospatial information processing servers 115 are provided in the form of geospatial information processing web service components. Further, the geospatial information processing server 115 provides users with service information on the respective web service components (e.g., an input/output data format, an input/output parameter, a function summary, a detailed function description, a processing size, a developer, a provider, an expected execution time, a network address or the like) in the form of a WSDL (Web Services Description Language) document or the like.

A user inputs a service request 131 to the geospatial information processing server 115, and then the geospatial information processing server 115 executes a geospatial information processing service by using its web service components. To be specific, by using the web service components, the geospatial information processing server 115 accesses a geospatial information database (hereinafter, referred to as a “geospatial information DB”) 125 to request a query 111 based on the received request, and receives a query result 112 from the geospatial information DB 125 in response to the query 111. Then, the geospatial information processing server 115 delivers a service execution result 132 to the user.

As shown in FIG. 1, the geospatial information DB 125 may be an external one provided by a geospatial information DB provider 120, which is different from the service provider 110. On the other hand, it may be disposed in or with the geospatial information processing server 115 by the service provider 110.

The user searches for an intended geospatial information processing unit function to be serviced through a client software 135 and selects a web service component corresponding to this function, wherein the client software 135 is installed in a user terminal 130 (e.g., in a hard disk drive) and equipped with a GUI (Graphic User interface) module 136. Through the client software 135, the user receives service information on the selected web service component, and then accesses the geospatial information processing server 115 to transmit the service request 131 in a proper form with reference to the received service information and receive the service execution result 132.

The GUI module 136, which supports a GUI environment and is included in the client software 135, performs search and selection of the web service component and access to the corresponding geospatial information processing server 115. More significantly, the GUI module 136 transmits the service request 131 by using control elements such as a menu, a button, an input window, an option, a slide bar, a viewer window or the like for the geospatial information processing service provided through the web service component, and receives and displays the service execution result 132 in response to the request.

Further, the client software 135 may include a BPM (Business Process Management) module 137 which is for generating a business process by combining a plurality of web services and performing the generated business process in case that a function requested by a user cannot be performed through a single geospatial information processing service. The BPM module 137 combines the plurality of web services by using an icon, a connection link, an option input, and a drag and drop, or the like to generate the business process.

Meanwhile, the service provider 110 may further include a load balancing server (not shown) for an efficient operation of the plurality of processing servers 115. The load balancing server may support a load balancing function adapted for distributed computing performed by the plurality of geospatial information processing servers 115 based on the amount of the service request from the user. That is, the load balancing server allows the plurality of processing servers 115 to perform distributed computing, thereby providing the geospatial information processing services.

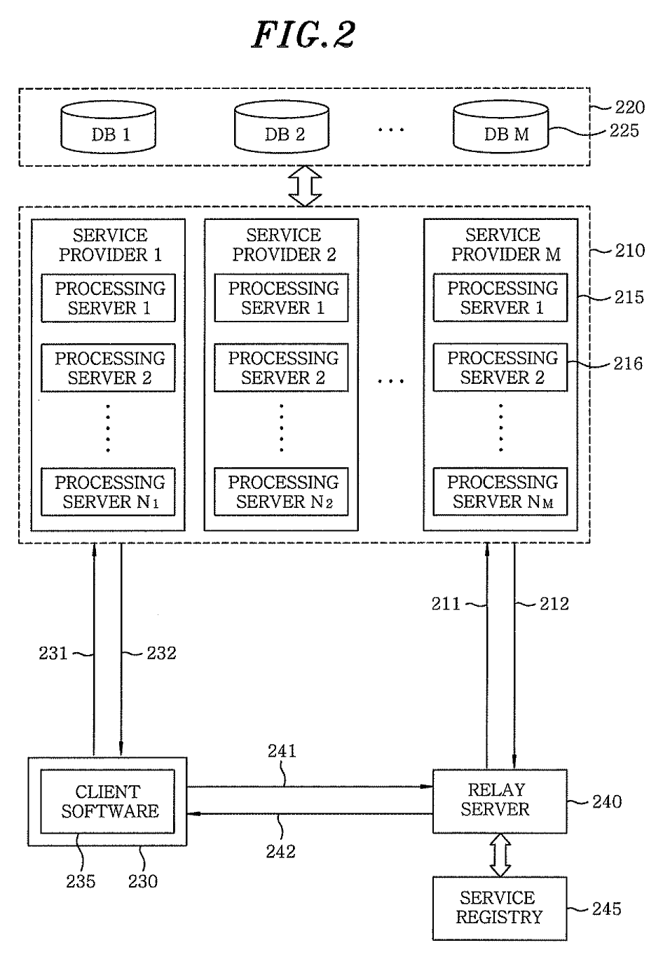

FIG. 2 illustrates a system for providing geospatial information processing services in accordance with another embodiment of the present invention. FIG. 2 shows an example where there is a plurality of service providers 215, each of which includes one or more geospatial information processing servers 216. Further, though FIG. 2 illustrates a case where a plurality of DBs 225 are provided by one geospatial information DB provider 220, it is apparent to those skilled in the art that the following description can be also applied to modified embodiments including cases where there is a single DB and where there are a plurality of DBs provided by a plurality of geospatial information DB providers. Further, although, for simplicity of description, FIG. 2 illustrates the plurality of service providers 215 as being grouped into one service provider group 210 and each DB 225, user terminal 230 and relay server 240 transmitting and receiving data to and from the service provider group 210, an actual data transmission/reception process is carried out between each geospatial information processing server 216 included in each service provider 215 and each DB 225, user terminal 230 or relay server 240.

If the system includes the plurality of service providers 215 as shown in FIG. 2, the relay server 240 may be intervened between the plurality of service providers 215 and a client software 235 installed in the user terminal 230 for the convenience of search, selection and operation of the web service component.

The relay server 240 receives a web service registration request 212 from the service providers 215 and records service information on each web service component into a service registry 245 such as a UDDI (Universal Description Discovery and Integration) registry or the like to thereafter manage and update the service information registered. In response to a geospatial information processing unit function search request 241 transmitted through the client software 235 of the user terminal 230, the relay server 240 searches for the corresponding service information in the service registry 245 and returns service information 242 in the form of a WSDL (Web Services Description Language) document or the like to the user.

The user refers to the service information 242 received from the relay server 240 to generate a service request 231 in a proper form for the respective web service components, and then transmits the service request 231 to the corresponding geospatial information processing server 216 of each service provider 215 directly or through the relay server 240. Then, the user receives a service execution result 232 in response to the service request 231.

Further, the relay server 240 may be scheduled to provide each service provider 215 with statistic information on the search requests from the user for the web service components registered in the service registry 245. Moreover, the relay server 240 may bill the user for the registered web service component use on behalf of each service provider 215.

Described in this embodiment are operations between the relay server 240 and the plurality of service providers 215. However, the relay server 240 can be used to manage a plurality of geospatial information processing web service components provided from a single service provider 215 more efficiently and to make search and selection of the user for the web service components and billing for the service use more convenient.

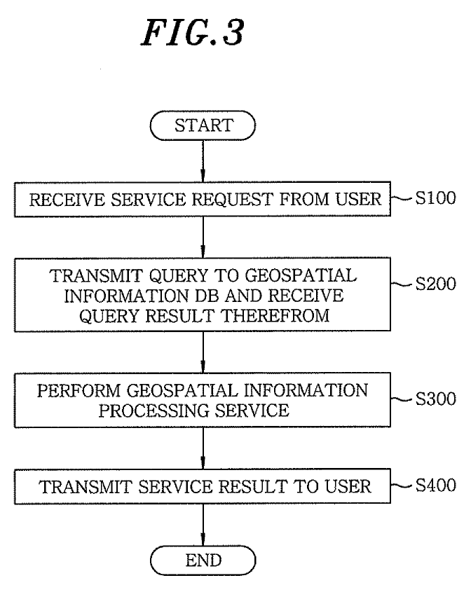

FIG. 3 illustrates a flow chart of a method for providing geospatial information processing services in the above-described geospatial information processing service provision system. The method described below is mainly based on the embodiment of FIG. 1, however, may be also applied to the embodiment of FIG. 2 and other modified embodiments.

The geospatial information processing server 115 receives from a user a service request 131 for a geospatial information processing service executed by one or more of the geospatial information processing web service components (step S100). The service request 131 includes information on the geospatial information processing web service components executing the corresponding geospatial information processing service. The user may use the client software 135 installed in the user terminal 130 to transmit the service request 131. To be specific, the GUI module 136 included in the client software 135 provides a graphic user interface for selection and use of the geospatial information processing web service components.

After that, the geospatial information processing server 115 accesses the geospatial information DB 125 to retrieve geospatial information necessary for performing the requested geospatial information processing service (step S200). The geospatial information processing server 115 transmits to the geospatial information DB 125 a query 111 based on the service request 131 and receives a query result 112 from the geospatial information DB 125.

Based on the query result 112, the geospatial information processing server 115 performs the requested geospatial information processing service (step S300). At this time, the geospatial information processing server 115 uses the geospatial information processing web service components.

Subsequently, the geospatial information processing server 115 transmits to the user the service execution result 132 of the step S300 (step S400). The service execution result 132 transmitted to the user is then displayed on the user terminal 130 by the GUI module 136 in the client software 135.

Though not shown in FIG. 3, in the series of procedures for providing geospatial information processing service, the geospatial information processing server 11S may register service information 242 on the geospatial information processing web service components to the service registry 245 and provide the user with the registered service information 242 via the relay server 240 (see FIG. 2 and its related description). In this case, the service information 242 provided to the user may be described in WSDL (Web Services Description Language).

While the invention has been shown and described with respect to the embodiments, it will be understood by those skilled in the art that various changes and modifications may be made without departing from the scope of the invention as defined in the following claims.

What is claimed is:

1. A system for providing geospatial information processing services using web service technologies via a network, the system comprising:
one or more geospatial information databases storing therein geospatial information;
a geospatial information processing service provider including one or more geospatial information processing servers having a plurality of geospatial information processing web service components for performing geospatial information processing unit functions; and
a user terminal including a client software for accessing the geospatial information processing servers via the network to select one or more of the geospatial information processing web service components and transmit a user request for a geospatial information processing service executed by the selected geospatial information processing web service components,
wherein the geospatial information processing servers accesses the geospatial information databases via the network to transmit a query based on the user request and receive a query result and transmits to the user terminal a geospatial information processing service result based on the query result received from the geospatial information databases, by using the selected geospatial information processing web service components.

2. The system of claim 1, further comprising:
a service registry registered therein service information on the geospatial information processing web service components; and
a relay server for receiving the service information on the geospatial information processing web service components from the geospatial information processing servers to register the service information in the service registry and for searching for the service information in the service registry to provide the user with the searched service information.

3. The system of claim 2, wherein the relay server bills the user for searching and using for the registered geospatial information processing web service components.

4. The system of claim 2, wherein the relay server provides the geospatial information processing service provider with statistic information on a user's use of the registered geospatial information processing web service components.

5. The system of claim 2,
wherein the relay server receives a request to register the service information on the geospatial information processing web service components from the geospatial information processing servers to register the service information in the service registry; and
wherein the relay server receives a search request from the user terminal to search for the service information in the service registry.

6. The system of claim 2, wherein the service registry is a UDDI (Universal Description Discovery and Integration) registry.

7. The system of claim 2, wherein the service information registered in the service registry is described in WSDL (web Services Description Language).

8. The system of claim 1, wherein the client software includes:
a GUI module for providing the user with a graphic user interface environment for selection and use of the geospatial information processing web service components; and
a BPM module for generating a business process by combining the geospatial information processing web service components to perform the business process by using the combined geospatial information processing web service components.

9. The system of claim 1, wherein the geospatial information databases are provided by the geospatial information processing service provider.

10. The system of claim 1, wherein the geospatial information databases are provided by one or more geospatial information database providers which are different from the geospatial information processing service provider.

11. The system of claim 1, wherein the geospatial information processing service provider further includes a load balancing server for supporting a load balancing function adapted for distributed computing performed by the geospatial information processing servers based on the amount of the service request from the user to provide the geospatial information processing services.

12. A method for providing geospatial information processing services using geospatial information stored in one or more geospatial information databases and a plurality of geospatial information processing web service components for performing geospatial information processing unit functions, the method comprising:
receiving from a user a user request for a geospatial information processing service executed by one or more of the geospatial information processing web service components;
transmitting to the geospatial information databases a query based on the user request and receiving a query result from the geospatial information databases;
performing the requested geospatial information processing service based on the query result by using the geospatial information processing web service components; and
transmitting to the user a geospatial information processing service result.

13. The method of claim 12, further comprising:
providing the user with service information on the geospatial information processing web service components.

14. The method of claim 13, wherein the service information is described in WSDL (Web Services Description Language).
